(19) United States
(12) Patent Application Publication
(10) Pub. No.: US 2005/0226685 A1
(43) Pub. Date: Oct. 13, 2005

(54) Retention structure

(75) Inventor: Heng-Chia Liao, Ping Tung City (TW)

Correspondence Address: TROXELL LAW OFFICE PLLC, Suite 1404, 5205 Leesburg Pike, Falls Church, VA, 22041, US

(73) Assignee: Golden Bridge Electech Inc.

(21) Appl. No.: 10/820,872

(22) Filed: Apr. 9, 2004

(51) Int. Cl. F16B 9/00

(52) U.S. Cl. 403/243

(57) ABSTRACT

A retention structure for mounting an antenna to a device casing is disclosed, including an outer collar having an end forming a circumferential retention flange, a portion of which is axially extended to serve as a stop, as least one retention projection being formed on an outside surface of the collar and extending from the retention flange; and an inner sleeve rotatably received in the collar and having a first end to which the antenna is attached and a free second end from which two axially extending slots are defined to divide the sleeve into two spaced, resilient portions, a stop block formed on the sleeve to cooperate with the stop of the collar for limiting rotation angle of the sleeve with respect to the collar. The collar is attached to the casing, while the sleeve is attached to the antenna. By the fast and secure engagement between the sleeve and the collar, the antenna is readily and securely mounted to the casing.

### FIELD OF THE INVENTION

The present invention generally relates to a retention structure, and in particular to antenna retention structure comprised of an outer collar and an inner sleeve cooperating to securely and fast mount an antenna to a device casing.

### BACKGROUND OF THE INVENTION

Conventionally, as shown in FIG. 5 of the attached drawings, to mount an antenna 5 to a device casing 6, the device casing 6 is formed with a hole 61 into which the antenna 5, which is an elongated bar-like object, is directly fit into the hole 61. A lead 51 of the antenna 5 is then coupled to a suitable position, such as a wireless network card to complete the mounting of the antenna 5 to the casing 6.

Mounting an antenna to a casing with the conventional manner suffers the drawback that a user may easily get the antenna 5 off the casing 6. Thus, such an antenna and casing assembly often disqualified to meet the requirement of FCC. Further, no retention structure is provided between the antenna 5 and the casing 6, which makes it impossible to adjust the position of the antenna 5 with respect to the casing 6.

Thus, the present invention is aimed to provide an antenna retention structure that securely retains an antenna on a casing to overcome the drawbacks of the conventional antenna-casing assembly.

### SUMMARY OF THE INVENTION

A primary objective of the present invention is to provide a retention structure that allows to securely and fast mount an antenna to a device casing.

To achieve the above objective, in accordance with the present invention, a retention structure is provided for mounting an antenna to a device casing. The retention structure comprises an outer collar having an end forming a circumferential retention flange, a portion of which is axially extended to serve as a stop, as least one retention projection being formed on an outside surface of the collar and extending from the retention flange; and an inner sleeve rotatably received in the collar and having a first end to which the antenna is attached and a free second end from which two axially extending slots are defined to divide the sleeve into two spaced, resilient portions, a stop block formed on the sleeve to cooperate with the stop of the collar for limiting rotation angle of the sleeve with respect to the collar. The collar is attached to the casing, while the sleeve is attached to the antenna. By the fast and secure engagement between the sleeve and the collar, the antenna is readily and securely mounted to the casing.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an outer collar of a retention structure constructed in accordance with the present invention;

FIG. 2 an exploded view of the retention structure of the present invention with an inner sleeve of the retention structure coupled to an antenna;

FIG. 3 is a perspective view showing the spatial relationship between an antenna, the retention structure of the present invention and a device casing;

FIGS. 4-1, 4-2 and 4-3 schematically show the operation of the retention structure of the present invention; and

FIG. 5 is a perspective view showing an antenna mounted to a device casing by a conventional manner.

### DETAILED DESCRIPTION OF THE PREFERRED EMBODIMENT

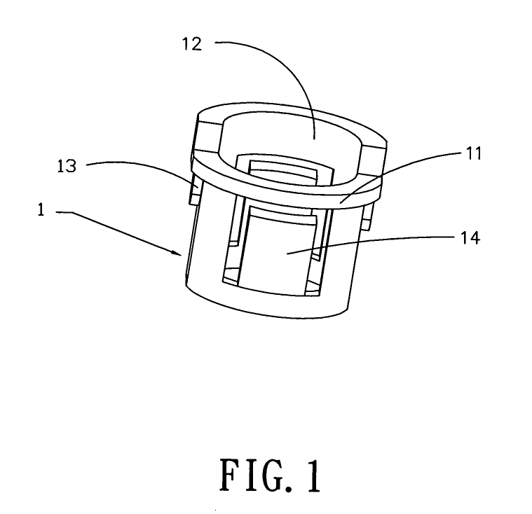

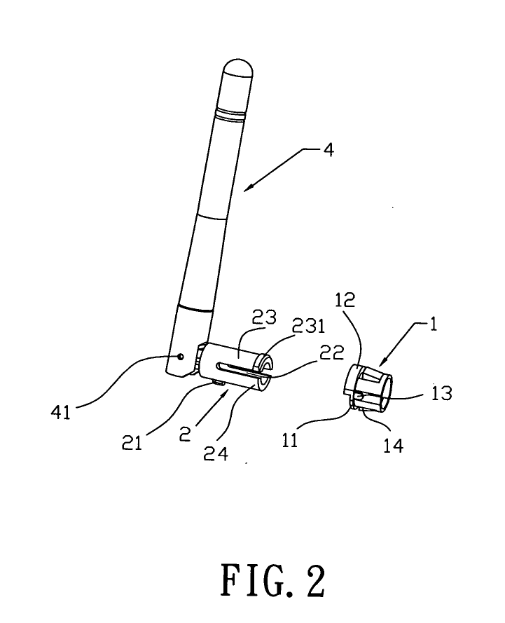

With reference to the drawings and in particular to FIGS. 1 and 2, a retention structure in accordance with the present invention mounts an antenna 4 to a casing device 3. The retention structure comprises an outer collar 1 and an inner sleeve 2, which cooperate to securely and fast mount the antenna 4 on the casing 3 and allow a lead (not shown) of the antenna 4 to be connected to a receiving device, such as a wireless network card (not shown).

The outer collar 1 is formed of a substantially cylindrical side wall (not labeled) and has axially opposite ends in one of which a circumferential flange 11 extending radially and outward beyond the side wall is formed. A portion of the flange 11 is extended axially to serve as a stop 12, which has opposite end walls in the circumferential length thereof. In the embodiment illustrated, the portion of the flange 11 from which the stop 12 extends occupies approximately one half of a circumferential length of the flange 11. In other words, the end walls of the stops 12 are angularly spaced by an angle of around 180 degrees. However, if desired, the stop 12 can be of greater or small circumferential length, namely the angle spacing the end walls is greater or smaller than 180 degrees. At least one retention projection 13 is formed on an outside surface of the side wall of the collar 1 and extends from the flange 11. The side wall of the collar 1 forms at least one resilient tab 14 having an end that is movable due to the resiliency and forms a barb (not labeled). The barb is spaced from the flange 11 a predetermined distance. In the embodiment illustrated, two retention projections 13 and two barbed tabs 14 are formed on the collar 1 and circumferentially alternate each other.

The inner sleeve 2 comprises a substantially cylindrical side wall (not labeled) rotatably receivable into the outer collar 1 and has two axially opposite ends of which one end is free and the other end is fixed to an antenna 4 by a pivot 41 to allow for adjustment of orientation of the antenna 4 with respect to the inner sleeve 2 and thus the retention structure. Alternatively, the antenna 4 is fixedly attached to the sleeve 2 at a predetermined angle. A stop block 21 is formed on an outside surface of the cylindrical side wall of the inner sleeve 2 to cooperate with the end walls of the stop 12 of the outer collar 1 to limit the rotation angle of the inner sleeve 2 with respect to the outer collar 1. Two slots 33 are defined in the side wall of the sleeve 2 and extend from the free end of the sleeve 2 to divide an axial length of the side wall into two spaced, opposite portions 23, 24. The sleeve 2 is made of such a material that makes the two portions 23, 24 resilient and thus elastically deformable. A rib 231 is formed on the outside surface of the portion 23 and extends along an outer circumference of the free end of the portion 23. If desired, a similar rib may be formed on the portion 24.

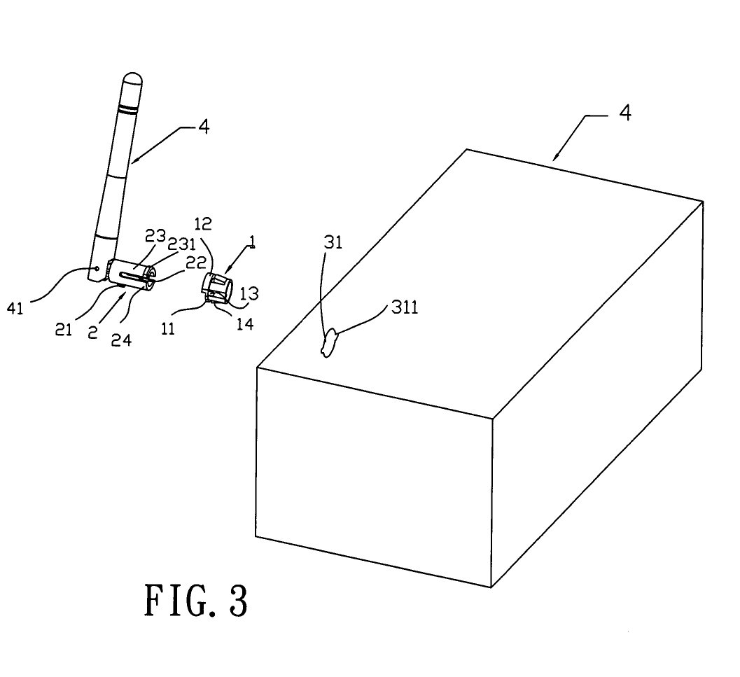

Also referring to FIG. 3, the device casing 3 forms an opening 31 at a suitable location for receiving and retaining the outer collar 1 therein. The thickness of the casing 3 is received in the space between the flange 11 and the barbs of the tabs 14 of the collar 1 when the collar 1 is fit into the opening 31. In other words, while the resiliency of the tabs 14 allows the barbs to resiliently deformed and pass through the opening 31, the flange 11 abuts against an outside surface of the casing 3 and the barbs of the tabs 14 are brought to contact an inside surface of the casing 3 by the resiliency of the tabs 14. This allows for fast mounting of the collar 1 to the casing 3 and also secures the collar 1 on the casing 3. The opening 31 defined in the casing 3 has two notches 311 formed in a circumferential edge thereof to snugly receive the retention projections 13 of the collar 1. This limits the rotation of the collar 1 with respect to the casing 3.

The resiliency of the portions 23, 24 allows the portions 23, 24 to elastically deform and readily fit into the collar 1. The rib 231 of the portion 23 is driven by the resiliency of the portion 23 to engage the axial end of the collar 1 that is opposite to the flange 11 once the sleeve 2 is fit into the collar 1. This secures the inner sleeve 2 to the outer collar 1 and thus the casing 3. The inner sleeve 2 is allowed to rotate with respect to the outer collar 1 and thus the casing 3 and the range of rotation angle of the inner sleeve 2 is delimited by the end walls of the stop 12 of the collar 1 and the stop block 21 of the inner sleeve 2.

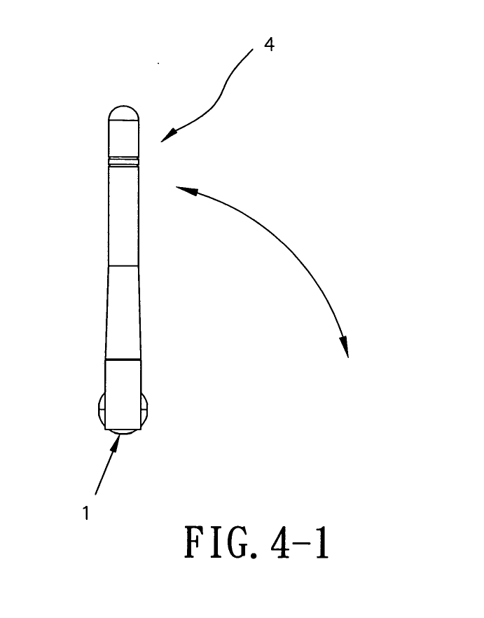

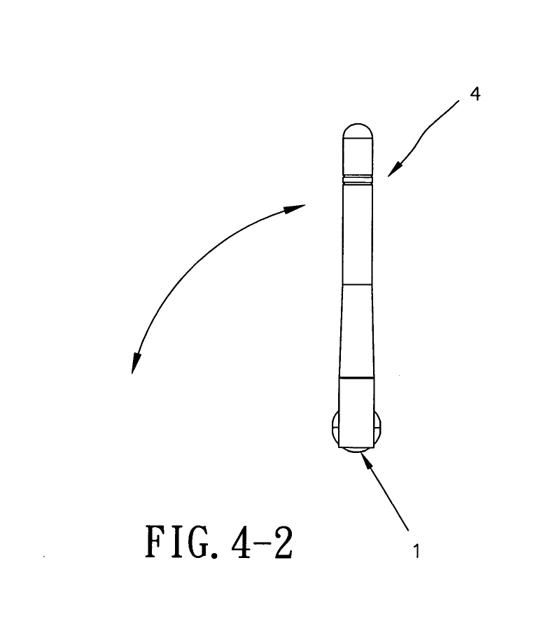

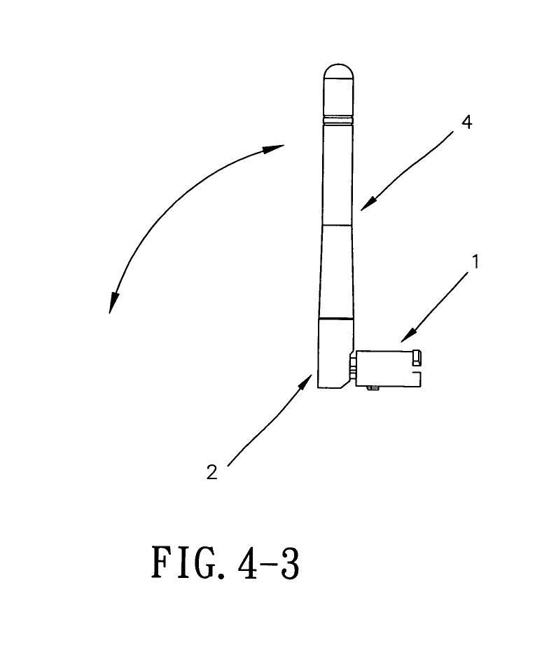

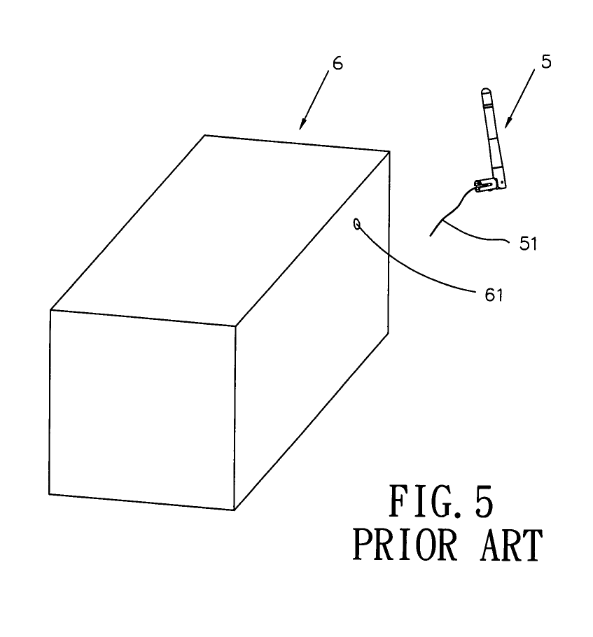

Also referring to FIGS. 4-1, 4-2 and 4-3, due to the rotatability of the inner sleeve 2 with respect to the outer collar 1, the antenna 4 that is attached to the inner sleeve 2 is allowed to orient at different angle with respect to the casing 3 by manually rotate the antenna 4 and the sleeve 2 about an axis of the collar 1. The manual rotation is limited 180 degrees in the embodiment illustrated due to the stop wall 12 of the collar 1 and the stop block 21 of the sleeve 2. Thus the adjustment of the orientation of the antenna 4 is limited in a range of 180 degrees, as illustrated in FIGS. 4-1 and 4-2, which shows the antenna 4 is rotated 90 degrees away from a neutral position rightward and leftward, respectively. This range, however, can be expanded/reduced by changing the circumferential length of the stop wall 12. Further, since the antenna 4 is attached to the sleeve 2 by the pivot 41, the antenna 4 is also allowed to rotate about the pivot 41 that is, in the embodiment illustrated, substantially perpendicular to the axis of the collar 1. This is illustrated in FIG. 4-3. Thus, the antenna 4 is allowed to rotate in two directions and the capability to orient the antenna in any desired direction is enhanced.

The retention structure of the present invention makes use of the outer collar 1 to realize secure mounting of the antenna 4 to the casing 3 whereby the antenna 4 so mounted to the casing 3 is secured from undesired separation from the casing 3 by the cooperation of the flange 11 and the barbed tabs 14 of the collar 1, which facilitates satisfaction of FCC regulation. Further, the collar 1 and the sleeve 2 together realize fast mounting of the antenna 4 to the casing 3.

Although the present invention has been described with reference to the preferred embodiment thereof, it is apparent to those skilled in the art that a variety of modifications and changes may be made without departing from the scope of the present invention which is intended to be defined by the appended claims.

1. A retention structure adapted to mount an antenna to a device casing, comprising:
an outer collar having an end forming a circumferential retention flange, a portion of which is axially extended to serve as a stop, as least one retention projection being formed on an outside surface of the collar and extending from the retention flange.

2. The retention structure as claimed in claim 1, wherein the collar forms at least one resilient barb.

3. The retention structure as claimed in claim 1, wherein the stop circumferential extends along approximately one half of a circumferential length of the circumferential retention flange.

4. The retention structure as claimed in claim 1, wherein the collar rotatably receives an inner sleeve having a first end to which the antenna is attached and a free second end from which two axially extending slots are defined to divide the sleeve into two spaced, resilient portions, a stop block formed on the sleeve to cooperate with the stop of the collar for limiting rotation angle of the sleeve with respect to the collar.

5. The retention structure as claimed in claim 4, wherein at least one of the portions of the sleeve forms a circumferentially extending rib.

6. The retention structure as claimed in claim 4, wherein the antenna is attached to the sleeve by a pivot.

7. The retention structure as claimed in claim 4, wherein the antenna is attached to the sleeve at a fixed angle.
